(19) United States
(12) Patent Application Publication
(10) Pub. No.: US 2010/0213263 A1
(43) Pub. Date: Aug. 26, 2010

(54) Electronic Article Surveillance Tag Assembly

(75) Inventors: Tsui Man Ho, Hong Kong (CN); Li Wei Song, Guang Dong (CN)

Correspondence Address: BROOKS KUSHMAN P.C., 1000 TOWN CENTER, TWENTY-SECOND FLOOR, SOUTHFIELD, MI, 48075, US

(73) Assignee: Advance Watch Company, Ltd., d/b/a, Geneva Watch Group, Long Island City, NY (US)

(21) Appl. No.: 12/711,559

(22) Filed: Feb. 24, 2010

Related U.S. Application Data
(60) Provisional application No. 61/154,858, filed on Feb. 24, 2009.

(51) Int. Cl. G06K 19/00; B65D 85/00

(52) U.S. Cl. 235/487; 206/307

(57) ABSTRACT

A housing for an electronic article surveillance (EAS) tag includes a first portion and a second portion fixable to one another for encasing an EAS tag. The housing includes a stationary tab that projects outward away from the housing and includes an aperture to assist in securing the housing to a shop article.

### CROSS-REFERENCE TO RELATED APPLICATIONS

This application claims the benefit of U.S. provisional Application No. 61/154,858 filed Feb. 24, 2009, the disclosure of which is incorporated in its entirety by reference herein.

### TECHNICAL FIELD

One or more embodiments of the present application are directed to electronic article surveillance tag assemblies.

### BACKGROUND

Electronic article surveillance (EAS) is a technology commonly used in the retail industry to identify articles as they pass through a gated area in a store. This identification is used to alert store personnel that unauthorized removal of items is being attempted. Using an EAS system enables a retailer to display items on a store floor, where they can be seen, rather than putting them in locked cases or behind a retail counter. There are several types of EAS systems, three of which dominate the retail industry. In each case, an EAS tag or label is attached to an article. Upon a valid purchase of the item, the tag can be removed or deactivated. A tag that is deactivated is taken from an active state where it will alarm an EAS system to an inactive state where it will not flag the alarm. If the tag is a “hard” reusable tag, a detacher is used to remove it when a customer purchases the article it is attached to. If the tag is a disposable tag, such as some paper tags or other EAS labels, it may be deactivated by swiping it over a pad or with a hand held scanner that “informs” the system that the article is authorized to leave the store. If the article has not been deactivated or detached by a store clerk, an alarm may sound when the article is carried through an EAS detection gate near a shop exit.

The three most commonly employed EAS systems include radio frequency (RF) systems, electromagnetic (EM) systems, and acousto-magnetic (AM) systems. The type of EAS system can dictate how wide an exit/entrance aisle to a store may be, and the physics of a particular EAS tag and technology can determine the frequency range used to create a surveillance area.

In RF systems, an RF tag attached to an article responds to a specific frequency emitted by a transmitter. The response from the RF tag may then be picked up by a nearby receiver. The receiver processes the RF tag response signal and triggers an alarm when specific criteria is matched. Operating frequencies for RF systems generally range from 2-10 MHz. RF systems may use a frequency sweep technique in order to accommodate different RF tag frequencies. To disarm an RF tag, typically a strong RF pulse blasts the tag and destroys electrical components such as a capacitor.

In EM systems, a magnetic strip with an adhesive layer can be attached to the merchandise. The magnetic strip is not removed at checkout, but rather is deactivated by a scanner or pad that uses a specific, highly intense, magnetic field. The magnetic strip of an EM tag has high permiability, making it easy for magnetic signals to flow through the strip. When the magnetic strip becomes saturated, from a magnetic perspective, it begins to look like air. Saturation of EM tags occurs abruptly and can be an important part of the design of the tag. A magnetized piece of magnetic material can be put up next to the active material in an EM tag to deactivate it. The magnetized piece of material is basically a weak magnet that saturates the tag and puts it in its inactive, saturated state. The EM system works by applying intensive low frequency magnetic fields generated by a transmitter. When the magnetic strip of the EM tag passes through an EAS gate, it transmits a unique frequency pattern. This pattern, in turn, can be picked up by a nearby receiver. The received signal is processed and will trigger an alarm when a specific pattern is recognized.

Acousto-magnetic (AM) systems use a transmitter to create a surveillance zone where EAS tags can be detected. The transmitter sends a radio frequency signal of about 58 kHz in pulses, which energizes a tag in the surveillance zone. When the pulse ends, the tag responds emitting a single frequency signal. While the transmitter is off between pulses, the tag signal can be detected by a receiver. The receiver may then check the tag signal to ensure that it meets specific criteria such as: the right frequency, its time-synchronization with the transmitter, the proper signal strength, and the correct repetition rate. If all of these criteria are met, the alarm may sound. AM material is highly magnetostrictive, which means that when the tag material is placed in a magnetic field, it physically shrinks thereby changing its resonant frequency. When the AM tag is demagnetized, it is deactivated. When it is magnetized, it is activated.

As previously mentioned, EAS tags may be disposable or reusable.

Disposable EAS tags and labels are available in many different types including pressure sensitive labels with simulated bar codes, tags or labels that can be imprinted with price, inventory, promotional or bar code information, and tags specially designed for products that are easily pocketed by shoplifters, or the like. These thin, adhesive backed labels can be as small as a paperclip and can be easily disguised to look like standard retail tags. The most familiar reusable EAS tag is known as a “hard tag.” The reusable hard tag is often attached to apparel and armed with a very difficult to defeat locking mechanism, which requires a special detacher unit to remove the tag.

EAS tags may also include radio frequency identification (RFID) technology. Dual EAS/RFID tags may be capable of simultaneously storing and processing information about an article while protecting the article from theft.

The components of an EAS tag or the tag itself often require protection. One or more embodiments of an EAS tag housing described herein may provide this protection.

### SUMMARY

According to one or more embodiments of the present application, an EAS tag housing may include a first portion having a floor and a peripheral wall orthogonal to the floor, which defines a cavity for an EAS tag. The EAS tag housing may also include a second portion adjoinable to the first portion and having a ceiling opposing the floor of the first portion for enclosing the EAS tag inside the cavity. The EAS tag housing may further include a stationary tab integrated with the first portion and projecting outward from the first portion. The stationary tab may project outward from an outer surface of the peripheral wall in a direction generally perpendicular to the outer surface. The stationary tab may include an aperture. At least one retention slot may be formed in one of the first or second portions. At least one retention tab corresponding to the at least one retention slot for insertion therein may be formed in the other of the first or second portions to secure the first portion to the second portion. At least a portion of the peripheral wall may include a recessed ledge. Moreover, the second portion may includes a peripheral lip opposite the peripheral wall that includes a mating surface that abuts the peripheral wall when the second portion is adjoined with the first portion. At least a portion of the peripheral lip may include a mating wall opposite the recessed ledge and extending orthogonally from the mating surface into the recessed ledge when the second portion is adjoined with the first portion. The first portion and the second portion may be generally rectangular such that the peripheral wall comprises a front wall, an opposing back wall, and two opposing side walls.

According to one or more alternate embodiments of the present application, an EAS tag assembly may include an EAS tag and a two-piece housing having a first portion and a second portion for enclosing the EAS tag. The first portion may include a floor and a peripheral wall orthogonal to the floor defining a cavity for the EAS tag. The second portion may be attachable to the first portion and include a ceiling opposite the floor. The EAS tag assembly may further include a stationary tab integrated with the first housing portion. The stationary tab may projecting outward away from the housing and include an aperture. The EAS tag may be selected from the group consisting of a radio frequency (RF) tag, an electromagnetic (EM) tag, and an acousto-magnetic (AM) tag. The first or second portions may include at least one retention slot and the other may include at least one retention tab corresponding to the at least one retention slot for insertion therein to secure the first portion to the second portion. The stationary tab may project outward from an outer surface of the peripheral wall in a direction generally perpendicular to the outer surface. At least a portion of the peripheral wall may include a recessed ledge. Moreover, the second portion may include a peripheral lip, opposite the peripheral wall, that includes a mating surface that abuts the peripheral wall when the second portion is adjoined with the first portion. At least a portion of the peripheral lip may include a mating wall opposite the recessed ledge. The mating wall may extend orthogonally from the mating surface into the recessed ledge when the second portion is adjoined with the first portion. Furthermore, the first portion and the second portion may be generally rectangular such that the peripheral wall comprises a front wall and an opposing back wall and two opposing side walls.

According to yet one or more alternate embodiments, an EAS tag assembly may include an EAS tag, a first housing portion, a second housing portion, and a stationary tab. The first housing portion may include a floor and a peripheral wall orthogonal to the floor. The peripheral wall may include a front wall, an opposing back wall, and two opposing side walls defining a rectangular cavity for the EAS tag. The second housing portion may align with the first housing portion and be attachable thereto. The second housing portion may include a ceiling opposing the floor of the first housing portion for enclosing the EAS tag inside the cavity. The stationary tab may be integrated with the first housing portion and include an aperture. The stationary tab may project outward from an outer surface of the peripheral wall in a direction generally perpendicular to the outer surface. One of the first or second housing portions may include at least one retention slot and the other may include at least one retention tab corresponding to the at least one retention slot for insertion therein to secure the first housing portion to the second housing portion. The EAS tag may be selected from the group consisting of a radio frequency (RF) tag, an electromagnetic (EM) tag, and an acousto-magnetic (AM) tag. At least a portion of the peripheral wall may include a recessed ledge. Moreover, the second housing portion may include a peripheral lip, opposite the peripheral wall, that includes a mating surface that abuts the peripheral wall when the second housing portion is adjoined with the first housing portion. At least a portion of the peripheral lip may include a mating wall opposite the recessed ledge. The mating wall may extend orthogonally from the mating surface into the recessed ledge when the second housing portion is adjoined with the first housing portion.

### BRIEF DESCRIPTION OF THE DRAWINGS

FIG. 1 is an exemplary perspective view of an EAS tag housing according to one or more embodiments of the present application;

FIG. 2a depicts an exemplary perspective view of a first portion of the EAS tag housing according to one or more embodiments of the present application;

FIG. 2b depicts an alternate view of the first portion of the EAS tag housing according to one or more embodiments of the present application;

FIG. 2c depicts yet another alternate view of the first portion of the EAS tag housing according to one or more embodiments of the present application;

FIG. 3a depicts an exemplary perspective view of a second portion of the EAS tag housing according to one or more embodiments of the present application; and

FIG. 3b depicts an alternate view of the second portion of the EAS tag housing according to one or more embodiments of the present application.

### DETAILED DESCRIPTION

As required, detailed embodiments of the present application are disclosed herein; however, it is to be understood that the disclosed embodiments are merely exemplary of an invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present application.

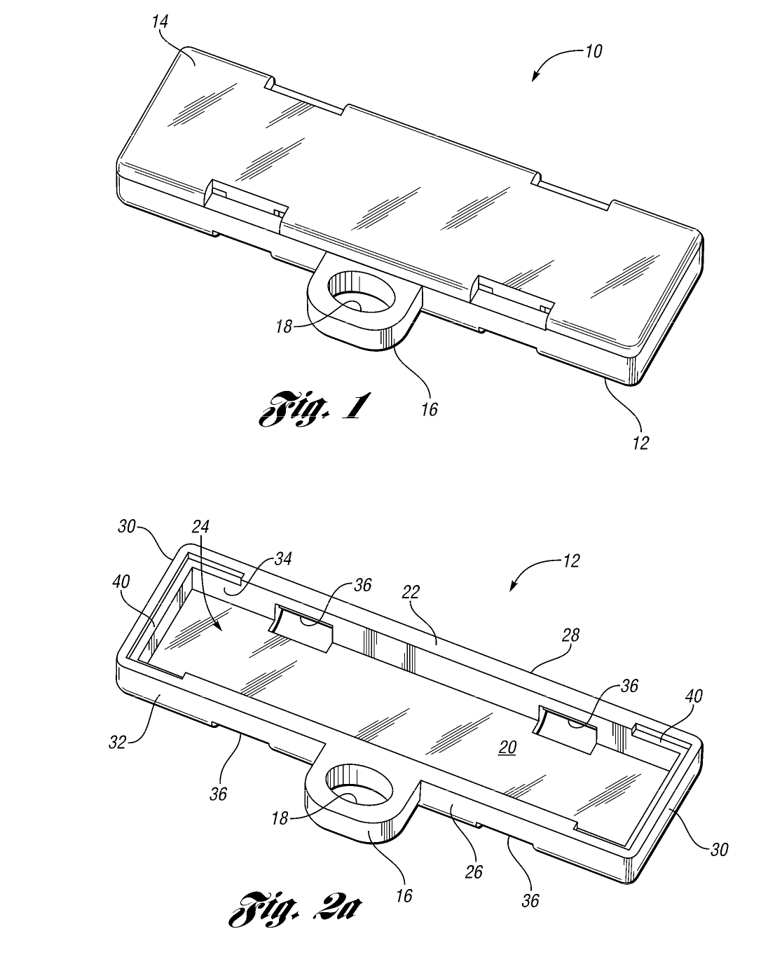

FIG. 1 depicts an EAS tag housing 10 according to one or more embodiments of the present application. The housing 10 can be a generally rectangular box-shaped housing having a first portion 12 and a second portion 14. Alternatively, the housing 10 may be cylindrical or some other geometrical shape. The first portion 12 may include a stationary tab 16 projecting outward from the housing 10. The stationary tab 16 may include an aperture or hole 18 for securing the housing 10 to an article (not shown).

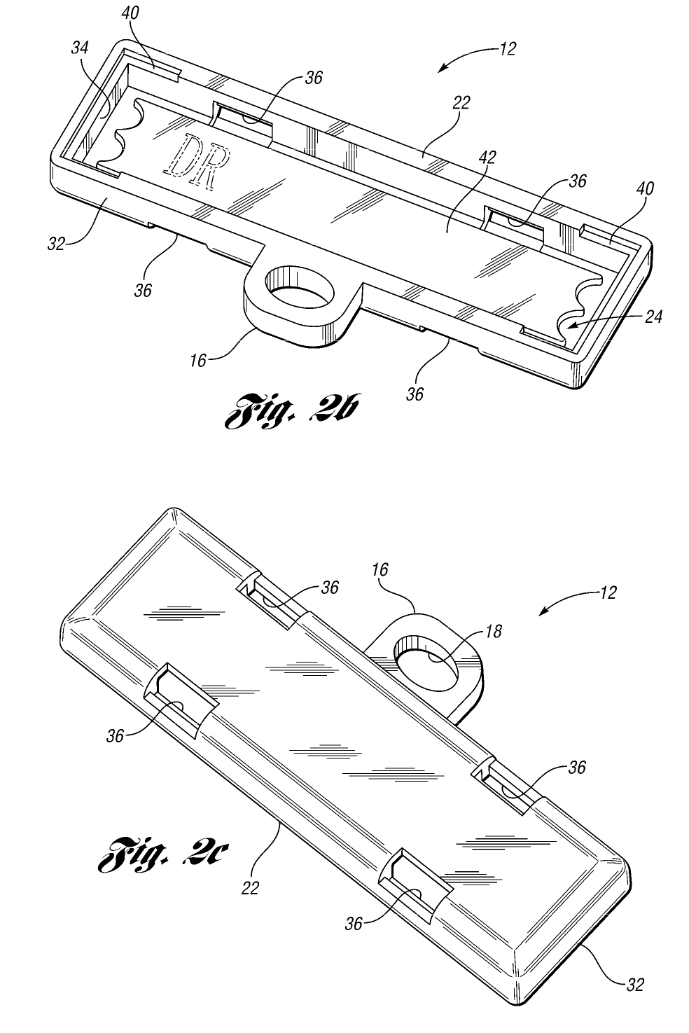

Referring generally to FIGS. 2a through 2c, more detailed exemplary views of the first portion 12 of the housing 10 are provided. FIG. 2a depicts the first portion 12 only of the housing 10 in a similar orientation to FIG. 1. As seen therein, the first portion 12 may include a floor 20. The floor 20 may be generally rectangular, as shown in FIG. 2a, for example, to conform with the box-shaped housing. A peripheral wall 22 may extend from the outer edges of the floor 20 to define a cavity 24 for receiving an EAS tag (not shown). In the example provided in FIG. 2a, the peripheral wall 22 may comprise four adjoining walls that are generally orthogonal to the floor 20. The four adjoining walls may include a front wall 26, an opposing back wall 28, and two opposing side walls 30 joining the front wall 26 to the back wall 28. Moreover, the peripheral wall 22 may include an outer surface 32 and an inner surface 34.

The stationary tab 16 may be formed integrally with the peripheral wall 22 and extend outward therefrom so as to form a protuberance from the peripheral wall 22 of the first portion 12. Particularly, the stationary tab 16 may project outward from the outer surface 32 of the peripheral wall 22 in a direction generally perpindicular to the outer surface 32. Accordingly, the stationary tab 16 may be fixed to the first portion 12 to minimize the number of moving parts.

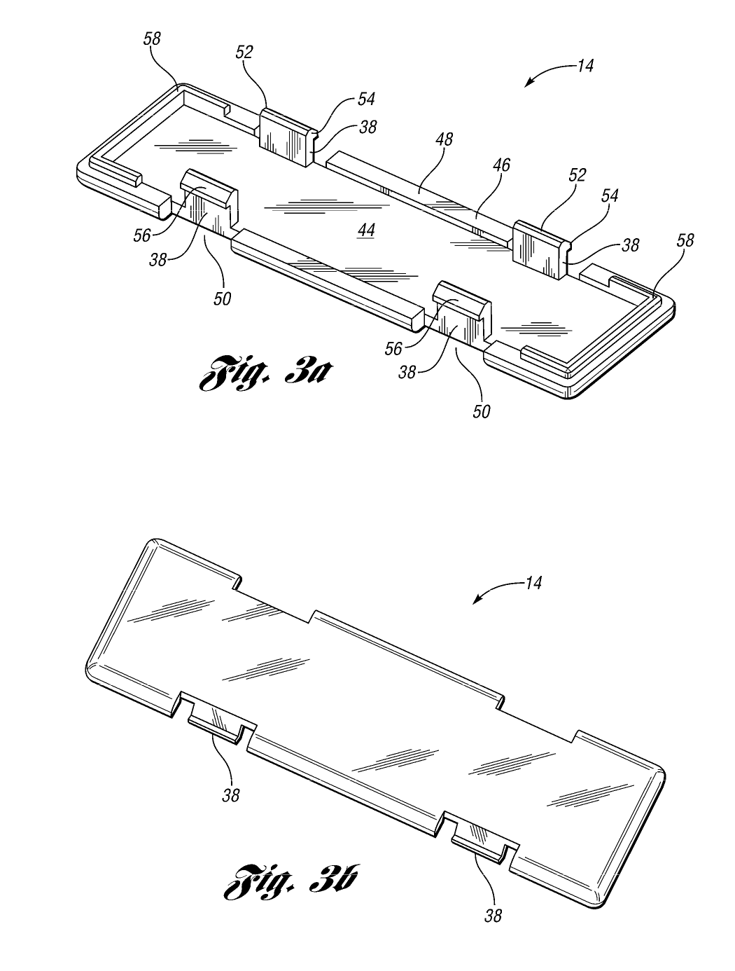

The first portion 12 may include a plurality of retention slots 36 for securing the second portion 14 to the first portion 12. As shown in FIG. 2a, one or more of the retention slots 36 may be formed at the junction between the floor 20 and the inner surface 34 of the peripheral wall 22. The plurality of retention slots 36 may be shaped to receive corresponding retention stabs 38, best shown in FIG. 3a, formed in the second portion 14.

The first portion 12 may further include at least one recessed ledge 40 formed in at least a portion of the peripheral wall 22 proximate the inner surface 34. As shown in FIG. 2a, the recessed ledge 40 may be formed in at least one of the two opposing side walls 30. Furthermore, the recessed ledge 40 formed in at least one of the side walls 30 may extend into a portion of the front wall 26, the back wall 28, or both.

Referring briefly to FIG. 2b, an exemplary view of the first portion 12 described in FIG. 2a is shown having an EAS tag 42 disposed within the cavity 24. FIG. 2c depicts an alternate perspective view of the first portion 12 of the housing 10.

Referring now to FIGS. 3a-3b generally, the second portion 14 of the housing 10 is shown in greater detail. The second portion 14 may be keyed to the first portion 12 and attachable thereto for enclosing the EAS tag 42 within the cavity 24.

As seen in FIG. 3a, the second portion 14 may include a ceiling 44 for opposing the floor 20 of the first portion 12. Accordingly, the ceiling 44 may be shaped similar to the floor 20 (e.g., rectangular). The ceiling 44 may be largely surrounded by a peripheral lip 46. The peripheral lip 46 may include a mating surface 48 that abuts the peripheral wall 22 of the first portion 12 when the housing 10 is assembled. A plurality of retention stabs 38 may extend orthogonally from the ceiling 44 at locations that correspond with the retention slots 36 formed in the first portion 12. Voids 50 may be formed in the peripheral lip 46 where each retention tab is located. An end 52 of each retention tab may include a hook 54 for securing the second portion 14 to the first portion 12 after the retention stabs 38 are inserted through the retention slots 36. Each hook 54 may include a leading edge angled sufficiently to ease the engagement of the second portion 14 with the first portion 12 through the retention slots 36.

The second portion 14 may also include at least one mating wall 58 extending from at least a portion of the peripheral lip 46 and keyed to the at least one recessed ledge 40 of the first portion 12. The mating wall 58 may be formed opposite the recessed ledge 40 and extend orthogonally from the mating surface 48 into the recessed ledge 40 when the second portion 14 is adjoined with the first portion 12. When assembled with the first portion 12, the mating wall 58 aligns with the corresponding recessed ledge 40 to help guide the second portion 14 and the first portion 12 together and offer additional stability to the housing 10. FIG. 3b depicts an alternate perspective view of the second portion 14 of the housing 10.

While exemplary embodiments of the invention have been illustrated and described, it is not intended that these embodiments illustrate and describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

What is claimed is:

1. An electronic article surveillance (EAS) tag housing comprising:
a first portion having a floor and a peripheral wall orthogonal to the floor defining a cavity for an EAS tag;
a second portion adjoinable to the first portion and having a ceiling opposing the floor of the first portion for enclosing the EAS tag inside the cavity; and
a stationary tab integrated with the first portion, the stationary tab projecting outward from the first portion and including an aperture.

2. The EAS tag housing of claim 1, wherein one of the first or second portions includes at least one retention slot and the other includes at least one retention tab corresponding to the at least one retention slot for insertion therein to secure the first portion to the second portion.

3. The EAS tag housing of claim 1, wherein the stationary tab projects outward from an outer surface of the peripheral wall in a direction generally perpendicular to the outer surface.

4. The EAS tag housing of claim 1, wherein at least a portion of the peripheral wall includes a recessed ledge.

5. The EAS tag housing of claim 4, wherein the second portion includes a peripheral lip opposite the peripheral wall that includes a mating surface that abuts the peripheral wall when the second portion is adjoined with the first portion.

6. The EAS tag housing of claim 5, wherein at least a portion of the peripheral lip includes a mating wall opposite the recessed ledge, the mating wall extending orthogonally from the mating surface into the recessed ledge when the second portion is adjoined with the first portion.

7. The EAS tag housing of claim 6, wherein the first portion and the second portion are generally rectangular such that the peripheral wall comprises a front wall and an opposing back wall and two opposing side walls.

8. An electronic article surveillance (EAS) tag assembly comprising:
an EAS tag;
a two-piece housing having a first portion and a second portion for enclosing the EAS tag, the first portion including a floor and a peripheral wall orthogonal to the floor defining a cavity for the EAS tag, the second portion attachable to the first portion and including a ceiling opposite the floor; and
a stationary tab integrated with the first housing portion, the stationary tab projecting outward from the housing and including an aperture.

9. The EAS tag assembly of claim 8, wherein the EAS tag is selected from the group consisting of a radio frequency (RF) tag, an electromagnetic (EM) tag, and an acousto-magnetic (AM) tag.

10. The EAS tag assembly of claim 8, wherein one of the first or second portions includes at least one retention slot and the other includes at least one retention tab corresponding to the at least one retention slot for insertion therein to secure the first portion to the second portion.

11. The EAS tag assembly of claim 8, wherein the stationary tab projects outward from an outer surface of the peripheral wall in a direction generally perpendicular to the outer surface.

12. The EAS tag assembly of claim 8, wherein at least a portion of the peripheral wall includes a recessed ledge.

13. The EAS tag assembly of claim 12, wherein the second portion includes a peripheral lip, opposite the peripheral wall, that includes a mating surface that abuts the peripheral wall when the second portion is adjoined with the first portion.

14. The EAS tag assembly of claim 13, wherein at least a portion of the peripheral lip includes a mating wall opposite the recessed ledge, the mating wall extending orthogonally from the mating surface into the recessed ledge when the second portion is adjoined with the first portion.

15. The EAS tag assembly of claim 14, wherein the first portion and the second portion are generally rectangular such that the peripheral wall comprises a front wall and an opposing back wall and two opposing side walls.

16. An electronic article surveillance (EAS) tag assembly comprising:
an EAS tag;
a first housing portion having a floor and a peripheral wall orthogonal to the floor, the peripheral wall including a front wall, an opposing back wall, and two opposing side walls defining a rectangular cavity for the EAS tag;
a second housing portion aligning with the first housing portion and attachable thereto, the second housing portion having a ceiling opposing the floor of the first housing portion for enclosing the EAS tag inside the cavity; and
a stationary tab integrated with the first housing portion and including an aperture, the stationary tab projecting outward from an outer surface of the peripheral wall in a direction generally perpendicular to the outer surface;
wherein one of the first or second housing portions includes at least one retention slot and the other includes at least one retention tab corresponding to the at least one retention slot for insertion therein to secure the first housing portion to the second housing portion.

17. The EAS tag assembly of claim 16, wherein the EAS tag is selected from the group consisting of a radio frequency (RF) tag, an electromagnetic (EM) tag, and an acousto-magnetic (AM) tag.

18. The EAS tag assembly of claim 16, wherein at least a portion of the peripheral wall includes a recessed ledge.

19. The EAS tag assembly of claim 18, wherein the second housing portion includes a peripheral lip, opposite the peripheral wall, that includes a mating surface that abuts the peripheral wall when the second housing portion is adjoined with the first housing portion.

20. The EAS tag assembly of claim 19, wherein at least a portion of the peripheral lip includes a mating wall opposite the recessed ledge, the mating wall extending orthogonally from the mating surface into the recessed ledge when the second housing portion is adjoined with the first housing portion.
